(19) United States
(12) Patent Application Publication
(10) Pub. No.: US 2005/0197942 A1
(43) Pub. Date: Sep. 8, 2005

(54) Computerized valuation platform

(76) Inventors: Steven M. Allaway, Mullno, OR (US); Peter A. Ackerman, West Linn, OR (US); Shawn C. Pilkington, West Linn, OR (US)

Correspondence Address: KOLISCH HARTWELL, P.C., 520 S.W. YAMHILL STREET, SUITE 200, PORTLAND, OR, 97204, US

(21) Appl. No.: 11/009,547

(22) Filed: Dec. 9, 2004

Related U.S. Application Data
(60) Provisional application No. 60/528,432, filed on Dec. 9, 2003.

(51) Int. Cl. G06F 17/60

(52) U.S. Cl. 705/35

(57) ABSTRACT

A computerized valuation platform. The computerized valuation platform can include a formula generator, a data acquisition mechanism, a valuation engine, and/or an information-presentation interface. The formula generator can be configured to publish one or more portable formula modules, wherein each portable formula module defines a valuation formula. The data acquisition mechanism can be configured to receive one or more values and assign the values to corresponding variables of the valuation formulas. The valuation engine can be configured to load a selected one of the published portable formula modules and calculate a valuation answer based on the loaded portable formula module and the assigned values corresponding to the variables of the valuation formula defined by the selected portable formula module. The information-presentation interface can be configured to present the calculated valuation answer.

### CROSS-REFERENCES

This application claims the benefit of U.S. Provisional Application No. 60/528,432, filed Dec. 9, 2003. The contents of the above referenced application are incorporated by reference.

### BACKGROUND

The valuation of an asset or a class of assets can be a difficult undertaking. This is especially true when more than one valuation method can be used to value the asset. Furthermore, when a valuation method requires a significant number of numerical calculations and/or difficult numerical calculations, using that valuation method can be effectively impossible without the use of computers. However, even with the assistance of computers, prior valuation methods have not been sufficiently flexible.

### BRIEF DESCRIPTION OF THE DRAWINGS

FIG. 1 schematically shows a computerized valuation platform.

FIGS. 2-5 show exemplary presentations of information from the computerized valuation platform of FIG. 1.

FIG. 6 schematically shows a distributed embodiment of the computerized valuation platform of FIG. 1.

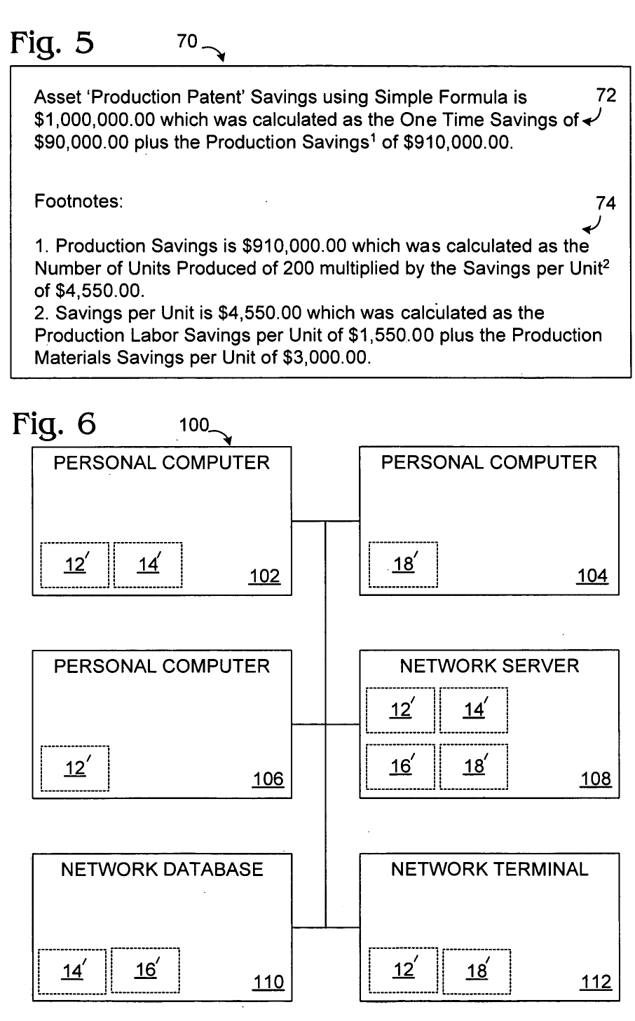

### DETAILED DESCRIPTION

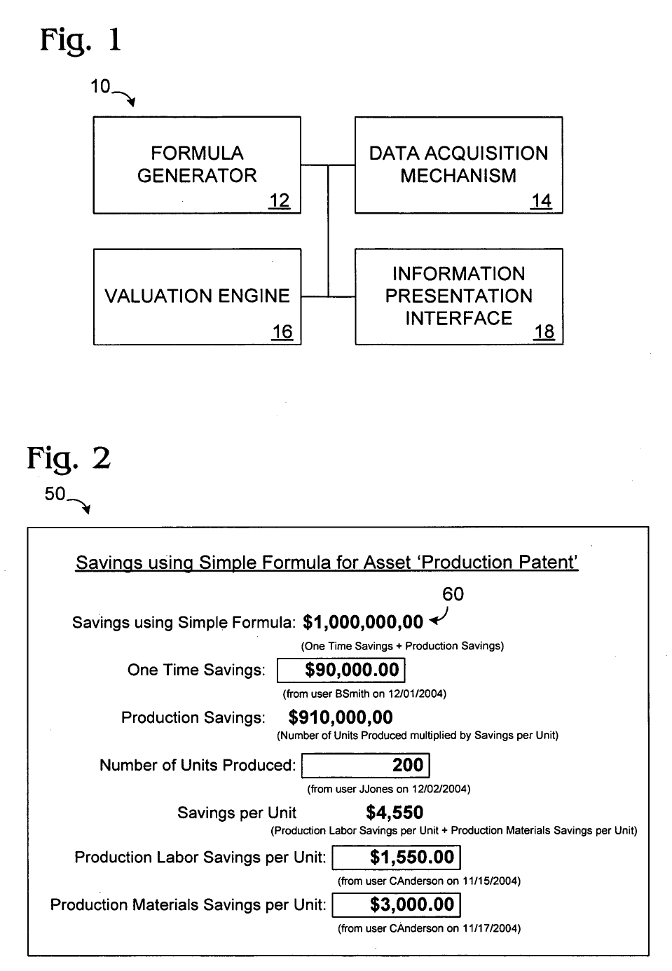

FIG. 1 schematically shows a computerized valuation platform 10 including a formula generator 12, a data acquisition mechanism 14, a valuation engine 16, and an information-presentation interface 18. Computerized valuation platform 10 can be used. to calculate the value of an asset, class of assets, and/or portfolio of assets. For example, as described herein, valuation platform 10 can be used to calculate the value of intangible assets, including but not limited to, intellectual property, such as patents, trademarks, copyrights, trade secrets, goodwill, etc. It should be understood that valuation platform 10 can also be used to calculate the value of assets other than intangible assets.

The desire and/or need to perform an asset valuation, in particular intangible asset valuation, can arise from a variety of different scenarios. The following table provides nonlimiting examples of some such scenarios.

| Reasons for | |
|---|---|
| Valuation | Examples |
| Transactional | Establishing a purchase or sale price |
| | for the transfer of the intangible |
| | Assessing the fairness of a proposed |
| | purchase or sale offer |
| | Assessing the reasonableness of a |
| | proposed royalty rate or transfer price |
| | for the license of the intangible |
| | Allocating equity in a business or |
| | joint venture formation based on the |
| | relative value of contributed intangibles |
| | Distributing assets in a business |
| | dissolution based on relative equity |
| | ownership |
| Financing | Assessing intangible asset collateral |
| | value for asset-based financing or |
| | cash flow-based financing |
| | Estimating the intangible asset value |
| | as part of a solvency opinion analysis |
| | Structuring a sale price and a periodic |
| | lease payment for intangible asset |
| | sales/leaseback financing |
| Taxation | Estimating the intangible asset fair |
| | market value for purchase price amortization |
| | Charitable contribution, abandonment loss, |
| | cancellation of indebtedness income (based |
| | on an insolvency test |
| | Partnership asset revaluation, and other |
| | federal income tax purposes |
| | Determining the value of a gift of |
| | intangible assets and concluding the value |
| | of intangible assets in a decedent's estate |
| | for federal gift and estate tax purposes |
| | Substantiating an arm's-length, inter- |
| | company transfer price for international |
| | transfers and income allocation purposes |
| | Estimating an assessment value for state and |
| | local ad valorem property taxation purposes |
| Bankruptcy | Assessing the solvency of the intangible |
| | asset owner/user |
| | Identifying debtor-in-possession intangible |
| | asset licensing or spin-off opportunities |
| | Establishing debtor-in-possession financing |
| | collateral value |
| | Analyzing the effect of intangible assets on |
| | various proposed plans of reorganization |
| Controversy/Litigation | Quantifying economic damages related to |
| | copyright, trademark, or other intellectual |
| | property infringement |
| | Estimating economic damages related to the |
| | breach of an intangible asset license or |
| | other contract |
| | Estimating fraud or misrepresentation |
| | damages; and qualifying lender liability |
| | damages |
| Management | Identifying, quantifying, and managing the |
| Information | value of the owner/user's intellectual |
| | property for: |
| | Determination of individual asset contribution |
| | for use in investment/divestment decisions |
| | Accounting |
| | Insurance |
| | Strategic planning |
| | Income (commercialization) projections |
| | Transfer pricing |
| | Substantiate Market value reporting |
| | Impairment testing for acquired intangible |
| | assets as required by FASB 142 |

Formula generator 12 can be configured to publish one or more portable formula modules. In some embodiments, formula generator 12 can include a computing system and associated software for publishing the portable formula modules. The portable formula modules can be a collection of computer readable information that defines one or more valuation formulas. In other words, the portable formula modules, for each defined valuation formula, can specify one or more variables and/or constants and the mathematical relationship between such variables and/or constants. The defined valuation formulas can be based off of known valuation formulas and/or the valuation formulas can be user-defined.

A portable formula module can define plural valuation formulas that are grouped together into the same publishable module. Likewise, plural valuation formulas can be separated into plural publishable modules. The same valuation formula can be defined by different portable formula modules. Such flexibility allows a particular portable formula module to define a desired group of valuation formulas. Bundling selected valuation formulas together can ease publishing, distribution, and user simplicity.

The portable formula modules can be published on a computer network so that they can be accessed by any valuation engine that has access to that network. The modules can be published with or without restriction. Unrestricted modules can be freely accessed, while restricted modules can not be accessed without permission. Access to restricted modules can be sold on a per user basis with or without time or usage restrictions. In other words, the portable formula modules can be controlled on a subscription basis. The modularity and portability of the platform allows a user to subscribe to only a desired set of valuation formulas, while being able to easily gain access to other valuation formulas by subscribing to different portable formula modules, which can be made readily available via a computer network, such as the Internet.

In some embodiments, computerized valuation platform 10 can include a user-control interface that is configured to facilitate building valuation formulas that can be published as constituent elements of a portable formula module. Such a user-control interface can allow a user to select variables and/or constants that are to be used in calculating a valuation answer, as well as define the mathematical relationship between such variables and/or constants. A user can select pre-defined variables, or if a desired variable has not already been defined, create new variables.

Data acquisition mechanism 14 can be configured to receive one or more values and assign the values to corresponding variables of the valuation formulas defined by one or more of the portable valuation modules. The data acquisition mechanism can be configured to receive values manually entered by a user, automatically accessed from a database or other source, and/or estimated based on other known information. A computer driven data acquisition mechanism can facilitate automated acquisition, such as pulling info from databases, tying the information to financial packages available via a computer network, and auto-publishing to a “valuation exchange.”

In some embodiments, a data acquisition mechanism can include a user interface for entering values, such as a world-wide-web based user interface. Furthermore, the data acquisition mechanism can be configured to automatically query a source to acquire a particular value to assign to a corresponding variable. To facilitate an automatic query, a valuation variable can be associated with a permissions set defining what type of source is most likely to have information that can be input for a particular variable. Various sources can be enrolled as one or more classes of sources, so that when an automatic query is desired, the data acquisition mechanism can query sources with the proper enrolment. A source can be queried in a variety of ways, depending on the type of source. If the source is a human being, the source can be e-mailed, or otherwise notified, that information is desired from the source. If the source is a database or other automated source, the source can be queried via an appropriate protocol.

In some embodiments, the data acquisition mechanism can be configured to acquire values according to a predetermined hierarchy, wherein low-hierarchy values are acquired before high-hierarchy values. As used herein, low-hierarchy is used to describe variables and associated values that are needed to calculate or use high-hierarchy variables and associated values. Similarly, high-hierarchy is used to describe variables and associated values that are calculated from low-hierarchy values and/or are used with other high-hierarchy variables in a calculation. Such a hierarchal data acquisition approach can reduce wasted effort by avoiding data acquisition of values that can not be used when values can not be acquired for underlying low-hierarchy variables.

In embodiments in which values are acquired via a user interface, the information presented by the user interface can be formatted to emphasize a hierarchical data acquisition approach. For example, low-hierarchy variables can be grouped together and presented apart from high-hierarchy variables to encourage a user to enter the low-hierarchy values before the high-hierarchy values. Therefore, if one or more low-hierarchy values can not be entered, the user can avoid expending effort determining and/or entering high-hierarchy variables that can not be used.

As a very simple example, assume a valuation formula of limited complexity: X=A+B*(C+D); where X is the desired valuation answer and A, B, C, and D are variables of the formula. The formula can be organized hierarchically:

$$X = A + X 1 = B * X 2 = C + D$$

In this example, temporary placeholders X1 and X2 represent the intermediate calculations of X1=(B*X2) and X2=(C+D). Organizing the data in this fashion, it becomes apparent that the priority of the inputs must be:

| Priority | Input |
|---|---|
| 1^{st} | C, D |
| 2^{nd} | B |
| 3rd | A |

Meaning that without the inputs C and D, both B and A are unnecessary, and without B, C and D, A is unnecessary. In other words, C and D are low-hierarchy variables relative to A and B, while B is a low-hierarchy variable relative to A and a high-hierarchy variable relative to C and D. Assuming that determining values to assign to the variables incurs real-world costs, it could be a waste of resources to calculate A if either B, C, or D is incalculable or prohibitively costly to determine. Moreover, if the sum of the inputs C and D equals zero, the input B is not needed as it has no possible effect upon X. Input A is hence ‘unlocked’ (needed) and b can be ignored or skipped.

It should be understood that the above is a non-limiting example. A hierarchal approach can be used with much more complicated valuation formulas. Furthermore, the visual arrangement of a formula can be changed from that provided in the example. Different hierarchal variables can be visually arranged in different columns from right to left or from left to right (as shown above). Similarly, the different hierarchal variables can be arranged in different rows from top to bottom or from bottom to top. In some embodiments, the different hierarchal variables can be sequentially presented, so that higher-hierarchy variables are not even visible until low-hierarchy variables are input. In some embodiments, a hierarchical list of variables can be output, thus serving as a tool that can be used away from a computer. Furthermore, it should be understood that manual input is only one possible way of acquiring a value for a variable, and that some values can be automatically acquired, such as by accessing a network database. As such, those variables may not need to be presented via a user interface even though they are necessary to calculate a valuation answer.

The data acquisition mechanism can store the acquired values in an accessible location, such as a computer database accessible via a computer network. The data acquisition mechanism can be configured so that once a value is entered for a particular valuation formula, the same value does not have to be re-entered for a different valuation formula that utilizes the same variable.

A certainty factor can be associated with an acquired value. Such a certainty factor can be used to indicate the likelihood of variation and/or the magnitude of variation for a particular acquired value. For example, a certainty factor can indicate that there is a 90% chance the value is correct and/or, if the value is incorrect, that it is incorrect by at most 20%. The certainty factor can be assigned based on the source of the value, the type of the value, the variation of values acquired from different sources (as explained below), and/or any other suitable criteria. A certainty factor can be associated with two or more different variables that are used in the same valuation formula, and any valuation answer, variable, and/or other data point that is affected by such variables can be associated with an aggregate certainty factor calculated from the individual certainty factors.

In some embodiments, the unavailability of a low-hierarchy value can be overcome by estimating a value. A user can estimate a value and/or a valuation engine can automatically estimate a value. In either case, a relatively low certainty factor can be assigned to the estimated value to reflect the uncertainty of the estimation.

More than one value can be acquired for a particular variable. For example, different values from different sources can be acquired for a single variable, which could be used in one or more valuation formulas. When two or more values are acquired, the values may be weighted so that they affect a valuation answer by a predetermined amount, which can be different from one another. For example, the values can be weighted according to the identity of the source of the value, the perceived or calculated certainty of the acquired valued, and/or any other suitable criteria. A value that is based on plural acquired values can be referred to as a derived value because it is derived from two or more different values. As with the value itself, a derived certainty factor can be calculated based on the individual certainty factors associated with the individual values acquired for a particular variable. The derived certainty factor can be calculated based on a weighting of the individual certainty factors.

Valuation engine 16 can be configured to load a selected one of the published portable formula modules and calculate a valuation answer based on the values assigned to the variables of a valuation formula of the loaded portable formula module. In other words, the valuation engine can be designed to carry out the logic defined in a given valuation formula using the values assigned to the variables of the valuation formula. As mentioned above, more than one value can be acquired for a particular variable. The valuation engine can be configured to calculate different valuation answers based on different values assigned to particular variables, and/or the valuation engine can be configured to calculate a derived valuation answer based on a derived value of a particular variable, which is based on different values acquired for that variable. The valuation engine may be configured to operate on a local and/or remote computing system.

Valuation engine 16 can be configured to make valuation calculations using ranged values. As used herein, a ranged value is a formula input that is not easily described as a single real number. For example, a ranged input could include a simple numeric range of possible values, such as y=[4, 7], meaning y is greater than or equal to four and less than or equal to seven. A ranged input could include the output of a function, such as y=mx+b, where m is a constant. In such situations, the valuation engine can calculate y for any desired x, resulting in a range of answers that can be denoted as y=[y₁, Y₂]. Accordingly, if [y₁, Y₂] is to be used in subsequent calculations, the valuation engine can utilize each y value in the interval [Y₁, Y₂]. If the subsequent calculation also is a ranged value, such as Z=x^{y}, the valuation engine can calculate Z for any desired value of x, while for each x using every y value in the interval [Y₁, Y₂]. As yet another example, a ranged value can be a collection of data points that are not easily defined as falling within an interval or resulting from a mathematical function. For example, a range value can include a set of numbers without any apparent mathematical relation, and such a ranged value can be used by a valuation formula. Calculations that involve ranged values can become quite complex, thus benefiting from the speed and accuracy of a computing system.

In some embodiments, a ranged value, or the result of a calculation that utilizes a ranged value, can be visually represented as a curve in two dimensional space or as a surface in three dimensional space. In some embodiments, a ranged value, or the result of a calculation that utilizes a ranged value, can be visually represented as a set of two or more curves or surfaces. Such visualization techniques can be used to help identify minimums, maximums, inflection points, or other useful results. The valuation engine can, of course, use standard computing analysis to identify such areas of interest. This process can be utilized to forecast the affect changing a value may have on a valuation answer. For example, a ranged value representing two or more possibilities can be input so that the different results can be compared. In some embodiments, the valuation engine can be configured to determine a particular value that produces a desired result by testing several, if not all possible, values for one or more variables. In this manner, different hypothetical scenarios can be pre-analyzed, thus providing guidance for obtaining a favorable valuation. Such information can then be used to modify business procedures in order to realize the forecasted result.

A ranged value can be used to represent a degree of uncertainty, a user's subjective input, as a modeling tool to analyze how changes to various inputs could affect a valuation answer, and/or virtually any other situation in which a single particular value is not appropriate or can not be readily acquired.

Information-presentation interface 18 can be configured to present the calculated valuation answer, intermediate results, assumptions, certainty factors, weighting, and/or other information. In some embodiments, such information can be visually presented, as described below. In some embodiments, the information can be presented as computer readable data, which can be saved in a modular format that may be distributed similarly to a portable formula module. Such a modular format can be referred to as a data module and may be variously formatted to cooperate with a selected protocol and/or data format. In this manner, the results of a valuation analysis can be accessed via a computer network. As with the portable formula modules described above, data modules can be offered on a subscription basis and/or can be made freely available.

The information-presentation interface can also be used to visually present the valuation answer and/or intermediate results, as well as other information. For example, assuming that the inputs for the formula detailed above, X=A+B*(C+D), have been entered, the valuation answer X can be displayed with an assumption tree showing the intermediate calculations and inputs, one level at a time. The source and date of the input can be associated with each input, and such source and date can be displayed as part of the assumption tree. An interactive assumption tree could allow any consumer of the valuation answer to see the exact means by which it was determined, along with the source and age of the inputs.

Whether the information is to be presented visually or in machine readable format, the information-presentation interface can be used to publish a self-contained document or file that can be used offline or by another computer system. Such a document can include a valuation answer, intermediate results, original data input, sources of data input, certainty factors, weighting, assumptions, and any other information relevant to the valuation based on the particular valuation formula being used.

In some embodiments, information-presentation interface 18 can present a certainty factor for a particular variable. Similarly, the information-presentation interface can present the weighting attributed to the source of a particular value. In some embodiments, such information can be graphically represented. For example, a graphic can be presented that shows the relative contribution of each variable in a valuation formula. This can be displayed as a pie chart, a bar chart, or in any other suitable format. For each variable, the relative weighting given to each source can be identified by relative area occupied in a chart.

In some embodiments, a valuation engine can be configured to execute a Monte Carlo valuation, in which two or more valuation answers, which result from different valuation formulas, can be compared and contrasted. Furthermore, certainty factors of completed valuations can be considered, thus providing a means for determining a favored valuation method for a particular scenario. In some embodiments, the computerized valuation platform can be configured to utilize two or more different valuation formulas to calculate a derived valuation answer, such as by averaging two or more valuation answers having at least a minimum certainty factor. As described above, valuation answers can be graphically represented one at a time. Furthermore, plural representations can be represented at the same time to assist in comparing different valuation answers and/or valuation formulas.

In some embodiments, partially complete valuation data from one source can be operatively merged with partial valuation data from another source, which can facilitate forecasting. For example, merged valuation data could be used to analyze how the merger of two separate entities, each with a separate portfolio of intellectual property, will affect the valuation of the combined portfolio of intellectual property. In some embodiments, independent parties attempting to value a single asset using the same valuation module can input data independent of one another, and without knowledge of the input of the other party. In such scenarios, the valuation engine can be configured to execute a double-blind valuation in which asset valuations are compared and contrasted while differences in the underlying data and assumptions are highlighted.

As described above, a valuation engine can calculate a valuation answer using different valuation formulas, which can be packaged in separate portable formula modules or bundled together in the same portable formula module. Furthermore, new valuation formulas can be published after a valuation engine or an information-presentation interface is designed. Therefore, to make use of different valuation formulas, including new valuation formulas, the valuation engine and the information presentation interface can be designed to interpret the valuation formula. In particular, the information-presentation interface can be configured to adapt presentation based on the particular valuation formula being used.

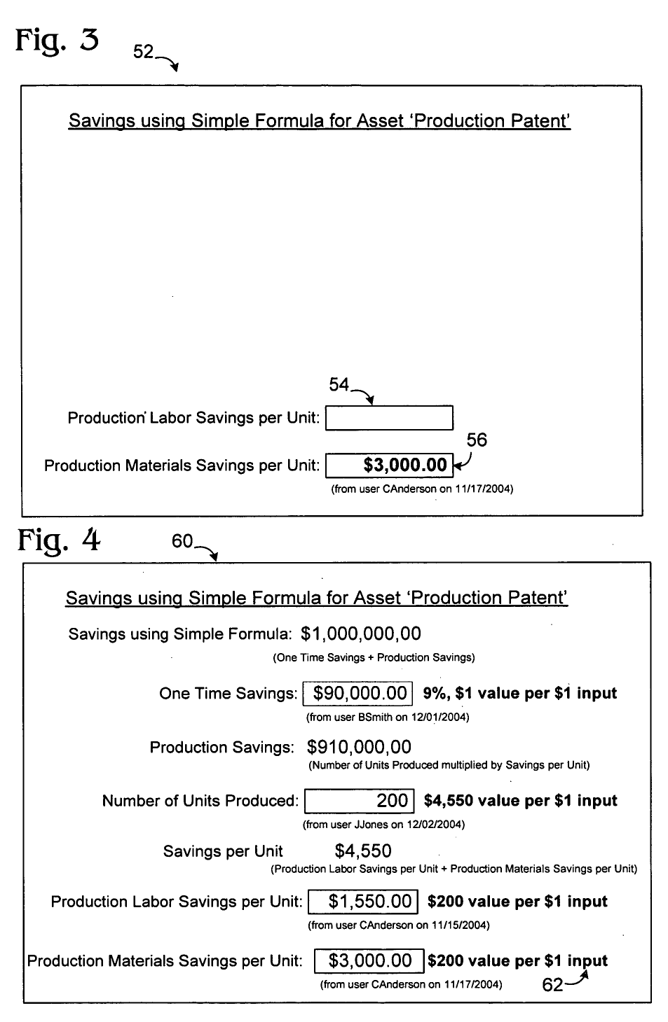

FIG. 2 shows an exemplary portion of a screenshot 50 in which the above described simplified valuation formula (X=A+B* (C+D)_has been used to calculate a valuation answer that enumerates the savings a business concern is estimated to realize by acquiring a production patent. It is important to understand that the portion of the screen that is shown is dynamically generated based on the particular valuation formula that is being used. If a different valuation formula were used, the screen would be dynamically formatted to display the information relevant to that formula.

As described above, the valuation formula can include low-hierarchy variables and high-hierarchy variables. As shown in FIG. 3, the information presentation interface can be configured to dynamically present only the variables within a selected hierarchical level, of which data input is presently desired. Such a hierarchical approach can prevent unnecessary data input, which can be a waste of resources. In particular, FIG. 3 shows a screen 52 in which only a field 54 for a Production Material Savings Per Unit variable and a field 56 for a Production Labor Savings Per Unit variable are shown. Field 54 has acquired a value of $3,000 on Nov. 17, 2004 from a source identified as C. Anderson. Field 56 has not yet acquired a value. Accordingly, variables that are higher in the hierarchy are not yet presented by the information-presentation interface.

Turning attention back to FIG. 2, screen 50 shows a view in which all of the variable fields have acquired associated values and a field 60 is displaying the valuation answer. This view reflects the hierarchy of the formula, in which low-hierarchy variables are located near the bottom of the screen (window), and the valuation answer is located near the top of the screen (window). It should be understood that other formats are possible, and the illustrated embodiment is provided as a non-limiting example. Furthermore, it should be understood that formatting can greatly vary depending on the complexity of the underlying valuation formula.

FIG. 4 shows a portion of a screen 60 in which the estimated savings attributed to each variable is presented. For example, at 62 it is shown that for every $1 the production patent saves in materials per unit (for example because a license to the patent is no longer needed, there is a total of $200 saved because there are a total of 200 units. Such contributions can be simultaneously calculated for all variables. Accordingly, any variable can be modified to analyze the affect such a change would have on the other contributions. Providing such information can facilitate easily understanding how an intangible asset can have a real-world affect on tangible assets.

As described above, the information-presentation interface can be used to present a valuation answer as well as intermediate results, underlying data, and/or other information. Because of the modularity of the valuation platform, the same information-presentation interface can be configured to present the information in a variety of different formats, so that an appropriate format can be selected for a particular purpose. FIG. 5 shows an example of one format that is different than the formats shown in FIGS. 2-4. In particular, FIG. 5 shows a portion of a screen 70, in which the valuation answer and other information is presented in the form of a textual insert 72 and footnotes 74. Such a format may be suitable for incorporation into a business brief, financial filing, or other document. As demonstrated in FIG. 5, the hierarchical approach can be reflected as a series of footnotes, in which a valuation answer and/or an intermediate result can reference a footnote that describes how the valuation answer and/or the intermediate result is calculated.

The description of the computerized valuation platform provided above is not intended to limit the hardware or software on which such a platform is deployed. In some embodiments, the platform can be a localized valuation platform in which all aspects of the platform execute on a single computer. In some embodiments, the platform can be a distributed platform in which some aspects run on one or more computers, while other aspects run on one or more different computers.

A nonlimiting example of a distributed platform 100 is shown in FIG. 2. Distributed computerized valuation platform 50 includes personal computers 102, 104, and 106 network server 108, network database 110, and network terminal 112. In the illustrated embodiment, personal computers 102 and 106, network server 108, and network terminal 112 include at least a portion of formula generator 12′. Personal computer 102, network server 108, and network database include at least a portion of data acquisition mechanism 14′. Network server 108 and network database include at least a portion of valuation engine 16′. Personal computer 104, network server 108, and network terminal 112 include at least a portion of information-presentation interface 18′.

The above example should not be interpreted to limit the application of a computerized valuation platform. Instead, the example shows that a constituent element of the platform can be physically embodied in different forms and/or at different locations. For example, as demonstrated by personal computer 104, it is shown that every distributed platform compatible device need not include a formula generator. Similarly, in some instances, two or more remote devices may cooperate together to collectively serve as a constituent element, such as a valuation engine or a data acquisition mechanism, while some elements may be replicated on different devices across the platform. Accordingly, distributed platform 100 is but one possible embodiment.

Although the present disclosure has been provided with reference to the foregoing operational principles and embodiments, it will be apparent to those skilled in the art that various changes in form and detail may be made without departing from the spirit and scope defined in the appended claims. The present disclosure is intended to embrace all such alternatives, modifications and variances. Where the disclosure or claims recite “a,” “a first,” or “another” element, or the equivalent thereof, they should be interpreted to include one or more such elements, neither requiring nor excluding two or more such elements.

1. A computerized valuation platform, comprising:
a formula generator configured to publish one or more portable formula modules, wherein each portable formula module defines a valuation formula;
a data acquisition mechanism configured to receive one or more values and assign the values to corresponding variables of the valuation formulas;
a valuation engine configured to load a selected one of the published portable formula modules and calculate a valuation answer based on the loaded portable formula module and the assigned values corresponding to the variables of the valuation formula defined by the selected portable formula module; and
an information-presentation interface configured to present the calculated valuation answer.

2. The computerized valuation platform of claim 1, wherein the formula generator is configured to publish formula modules that define two or more valuation formulas.

3. The computerized valuation platform of claim 1, wherein the valuation formula is an intangible asset valuation formula.

4. The computerized valuation platform of claim 1, wherein the formula generator is configured to build a valuation formula from at least one of pre-defined variables and newly defined variables.

5. The computerized valuation platform of claim 1, further comprising a user-control interface, wherein the formula generator is configured to build a valuation formula responsive to commands received via the user-control interface.

6. The computerized valuation platform of claim 1, wherein the valuation engine can subscribe to portable formula modules, and wherein the valuation platform further comprises a subscription controller configured to restrict the valuation engine from loading any portable formula module to which the valuation engine is not subscribed.

7. The computerized valuation platform of claim 1, wherein the data acquisition mechanism includes a user interface that requests values according to a prioritized hierarchal structure in which high-hierarchy values that are dependant upon low-hierarchy values, as defined by a valuation formula of the loaded published portable formula module, are not requested until the low-hierarchy values are input.

8. The computerized valuation platform of claim 1, wherein the data acquisition mechanism is configured to receive different values from different sources for a single corresponding variable of the valuation formula, and wherein the data acquisition mechanism is configured to assign a derived value based on the different received values for the single corresponding variable of the valuation formulas.

9. The computerized valuation platform of claim 8, wherein the derived value is weighted according to respective sources of the received values on which the derived value is based.

10. The computerized valuation platform of claim 8, wherein the data acquisition mechanism is configured to record an identity of a source of a received value and a date of reception, and wherein the information-presentation interface is configured to present at least one of the identity and date of reception.

11. The computerized valuation platform of claim 10, wherein the valuation engine is configured to determine a total contribution a selected source has on the calculated valuation answer.

12. The computerized valuation platform of claim 10, wherein the valuation engine is configured to limit a total contribution a selected source has on the calculated valuation answer.

13. The computerized valuation platform of claim 1, wherein the data acquisition mechanism is further configured to receive a certainty factor corresponding to a received value.

14. The computerized valuation platform of claim 1, wherein the data acquisition mechanism is configured to receive different values from different sources for a single corresponding variable of the valuation formula and receive a certainty factor corresponding to each of the received values, and wherein the data acquisition mechanism is configured to assign a derived value based on the different received values and associate a derived certainty factor, based on the received certainty factors, with the derived value.

15. The computerized valuation platform of claim 14, wherein derived certainty factors are used as inputs to one or more valuation formula resolution functions.

16. The computerized valuation platform of claim 14, wherein derived certainty factors are used to adjust a valuation answer.

17. The computerized valuation platform of claim 1, wherein the valuation engine is further configured to calculate a certainty factor corresponding to the valuation answer, and wherein the information-presentation interface is further configured to present the certainty factor.

18. The computerized valuation platform of claim 1, wherein the valuation engine is configured to calculate a ranged valuation answer responsive to a ranged value being assigned to at least one of the variables of the valuation formula defined by the selected portable formula module.

19. The computerized valuation platform of claim 18, wherein the valuation engine is configured to calculate high-hierarchy ranged values that are dependant upon low-hierarchy ranged values.

20. The computerized valuation platform of claim 19, wherein the valuation engine is configured to calculate multiplicative high-hierarchy ranged values resulting from a low-hierarchy ranged value used in conjunction with another low-hierarchy ranged value.

21. The computerized valuation platform of claim 18, wherein the information-presentation interface is configured to present the calculated ranged valuation answer as a range of probability curves that accommodate ranged values assigned to the variables of the valuation formula defined by the selected portable formula module.

22. The computerized valuation platform of claim 21, wherein the information-presentation interface is configured to present a hierarchical view of at least some of the variables used to calculate a valuation answer, wherein ranged values are represented non-linearly.

23. The computerized valuation platform of claim 1, wherein the valuation engine is configured to calculate a contribution for each variable, and wherein the information-presentation interface is configured to graphically indicate the contribution of each variable.

24. A method of valuating intellectual property, comprising:
publishing one or more portable formula modules on a computer network, wherein each portable formula module defines a valuation formula;
selecting a published portable formula module;
assigning values to variables of the valuation formula;
calculating a valuation answer using the valuation formula of the selected published portable formula module; and
presenting the calculated valuation answer.

25. An article comprising: a computer-readable storage medium having machine readable instructions that, upon execution by a computer system, provide for:
publishing one or more portable formula modules on a computer network, wherein each portable formula module defines a valuation formula;
acquiring values corresponding to variables of a valuation formula of a selected one of the portable formula modules;
calculating a valuation answer using the valuation formula from the selected published portable formula module; and
presenting the calculated valuation answer.
